(19) United States
(12) Patent Application Publication
(10) Pub. No.: US 2002/0094508 A1
(43) Pub. Date: Jul. 18, 2002

(54) Rotary osteotome for dental implant

(76) Inventor: Lawrence P. Lorenzi, Newport Beach, CA (US)

Correspondence Address: Lawrence P. Lorenzi, Suite 505, 1441 Avocado Avenue, Newport Beach, CA, 62660, US

(21) Appl. No.: 09/761,798

(22) Filed: Jan. 17, 2001

(51) Int. Cl. A61C 3/02; A61C 8/00

(52) U.S. Cl. 433/165; 433/174

(57) ABSTRACT

A rotary osteotome for widening a dental implant site in preparation to receive a dental implant. The osteotome includes a tapered body tapered from a tip thereof to a widened intermediate region, with at least a part of the tapered body being threaded. The threads are feeding threads constructed to draw the tapered body into the implant site responsive to rotation thereof. A coupling provides detachable engagement with a surgical drill or hand wrench for forward and reverse rotation of the osteotome. A kit of such osteotomes includes osteotomes of gradually increasing diameters, with the diameter of the intermediate region of a first osteotome being slightly larger than the diameter of th tip for a subsequent osteotome, thereby providing for gradual widening of the implant site.

### BACKGROUND OF THE INVENTION

1. Field Of The Invention

The present invention relates to an osteotome for preparation of a dental implant site and in particular to osteotomes for widening the dental implant site in preparation to receive an implant.

2. Description Of The Related Art

Dental implants are three-part devices consisting of a titanium cylinder (the “implant”), an intermediate portion (the “abutment”), and a porcelain crown (the visible chewing portion). Dental implants are placed into the upper or lower jaw bone and can be used to replace a single or multiple missing teeth, or several can be placed to support a denture. The upper end of the implant cylinder is internally threaded to receive the abutment and crown. The lower end is shaped for implantation into the bone of the upper or lower jaw. Depending upon the specific manufacturer, the external surface of the implant is cylindrical or slightly tapered. Most are threaded to engage the jaw bone.

Good bone healing and atraumatic surgical technique are both important to dental implant success. As a consequence, following extraction of a natural tooth, implant surgery usually commences after a waiting period of several weeks, during which trauma to the bone is reduced naturally and during which the bone grows to fill the cavity left by the natural tooth. Following this waiting period, a cylindrical pilot hole is drilled into the bone as the first step in the surgical process. The cylindrical pilot hole is then widened by one of two conventional techniques.

According to the first technique, drills of successively larger diameters are used to remove bone tissue from the implant site and thereby increase the implant site diameter until the final drill is the same diameter as the implant. In cases where dense bone is involved, such as the lower jaw, the implant site is often threaded internally with a bone tap being used as the final drill. The cylindrical implant is then threaded into or inserted into the prepared implantation site.

This fist technique requires adequate bone width because of the removal of bone. Removal of large amounts of bone is ordinarily undesirable since bone removal weakens the implant site. Accordingly, this first technique for preparation of the implant site is used sparingly or is used in combination with the second technique (described below) which involves widening of the pilot hole without additional removal of bone.

According to the second technique for preparation of the implant site, after the cylindrical pilot hole is drilled, multiple osteotomes are used (with a mallet and chisel technique) to enlarge the implant site without further removal of bone. Each osteotome is sized successively larger than the previous osteotome, and the osteotomes are used until the site has a diameter that corresponds to that of the implant. As before, implant site may then be threaded to receive a threaded implant cylinder, and the implant is then inserted or rotated into the prepared site.

Following insertion of the implant cylinder into the implant site, a second healing period of a few months commences, during which bone re-grows and anchors the implant cylinder into place. The implant is thereafter exposed for use in which the crown, bridge, or dental substructure is then permanently affixed to the upper end of the implant via the abutment.

Since use of osteotomes to prepare the implant site preserves rather than removes bone, it is preferable to prepare the implant site through use of osteotomes according to the second technique, rather than to prepare the implant site through bone removal according to the first technique. One currently available osteotome kit includes a series of osteotomes each with increasingly larger diameters and generally being punch-shaped. In use, after the pilot hole is drilled, a first osteotome of smallest diameter is inserted into the implantation site and is gently hammered into the site until the desired implant depth which is shown by reference lines etched into the surface of the osteotome, after which the osteotome is withdrawn. A second osteotome of next larger diameter is then inserted into the implantation site and hammered into place and withdrawn as before. The process continues until the desired diameter is reached. The benefit of this process is that the desired diameter is reached without undue removal of bone, being acknowledged that good bone structure is important for firm anchoring of the implant.

Despite the advantages of osteotome preparation of implant sites, currently available osteotomes have disadvantages. In particular, hammering of osteotomes is traumatic to the bone and is uncomfortable to an awake patient. Moreover, despite proper alignment of the pilot hole, alignment of the implantation site can easily drift since the osteotomes are hammered manually into place. Particularly with narrow implantation sites such as a thin jaw bone, it is possible for the osteotome to perforate the side of the implantation site. Additionally, hammered osteotomes often become embedded in the bone and require considerable force to remove.

### SUMMARY OF THE INVENTION

The invention has been made in recognition of the disadvantages of currently available osteotomes, and in recognition of the advantage of osteotomes in avoiding undue removal of bone.

Thus, in one aspect the invention is a rotary osteotome with a tapered shape having a finely threaded exterior surface. The threads are constructed to feed the osteotome into the implantation site in response to rotation of the osteotome, ordinarily without any significant cutting or removal of bone. The osteotome thus widens the implantation site by being rotated into the site and drawn thereinto by the threads, which engage the bone at the interior of the implantation site. The implantation site is thus widened by virtue of the osteotome's tapered shape. The osteotome is then retracted from the site by reverse rotation and the process then repeated with an osteotome of a next larger size. For convenience, each osteotome includes a coupling that fits into the drill mount of a standard drill or hand wrench for oral surgery.

Once a hole of desired diameter is obtained at the implantation site, implantation proceeds as before. For example, threads might cut in the interior of the bone, or other final shaping might be performed, in preparation for receiving the implant cylinder.

Because the osteotome is drawn in smoothly by its threads, there is considerably less trauma than with conventional mallet type osteotomes, and the advantage of widening without removal of bone tissue is preserved. In addition, retraction is easy and assured since reverse rotation acts to back the osteotome out of the implantation site. Moreover, preparation of the implantation site is faster, and alignment more accurate than with conventional equipment.

In preferred embodiments, multiple osteotomes of successively larger sizes are provided in an osteotome kit. The kit allows the dental surgeon to prepare the site quickly through selection of suitably-sized osteotomes, and preferably includes pilot drills for drilling pilot holes of appropriate diameter.

In use, the implantation site is established by drilling a pilot hole and is otherwise prepared as deemed necessary by the surgeon. The osteotome is rotated into the implantation site and is drawn into the implantation site by its threads, which engage the bone at the interior thereof. Rotation is preferably accomplished through coupling of the osteotome to a surgical drill although manual rotation by a surgical hand wrench is possible. The hole at the implantation site is thereby widened by virtue of the osteotome's tapered shape. The osteotome is then retracted from the site by reverse rotation and the process repeated until an implantation site of desired size is obtained.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 is a perspective view of a rotary osteotome according to the invention.

FIG. 2 is a perspective view of an osteotome kit including plural osteotomes and pilot drills.

FIG. 3 is a view for explaining use of an osteotome according to the invention.

### DETAILED DESCRIPTION OF THE PREFERRED EMBODIMENTS

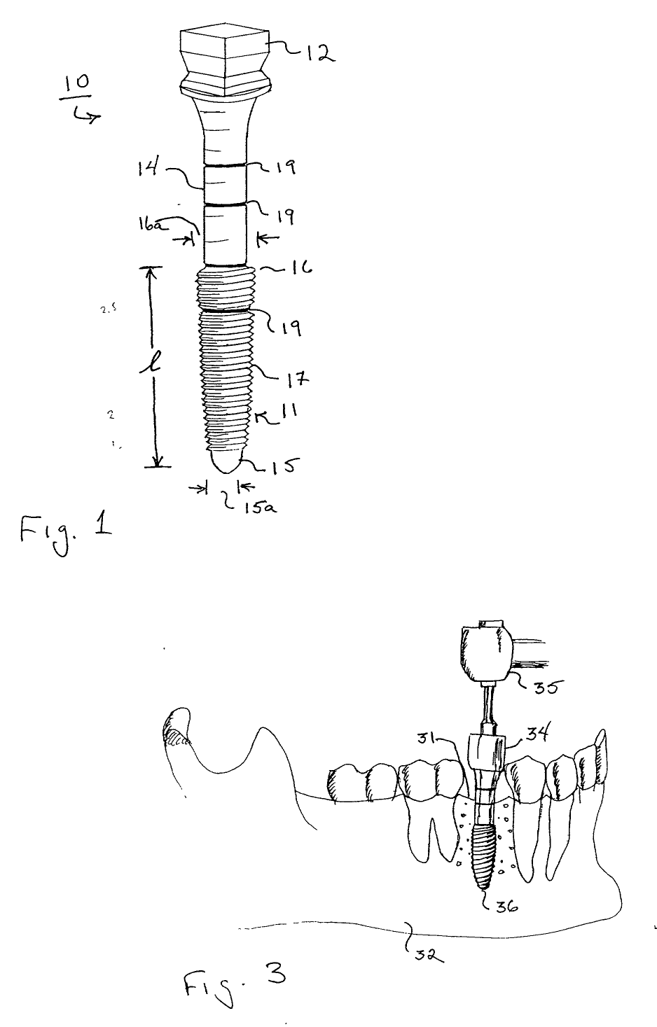

FIG. 1 shows a representative embodiment of a rotary osteotome 10 according to the invention. As seen in FIG. 1, rotary osteotome 10 includes a tapered body 11 adapted for rotational insertion into an implantation site through rotation at coupling 12. Coupling 12 is constructed for coupling to an unshown drill mount of a standard dental drill (or to a surgical hand wrench) and is generally square-shaped to facilitate such coupling. An unthreaded shaft 14 is provided between coupling 12 and tapered body 11.

Tapered body 11 tapers gradually and preferably in a straight or curved line from adjacent tip 15 to an intermediate region 16 which is widened relative to tip 15. In particular, the diameter 15a at the tip 15 is smaller than diameter 16a at intermediate region 16. The increase in diameter is designed such that bone fracture is avoided as the osteotome is inserted over the length L of tapered body 11. Preferably, the increase in diameter is between about 0.25 mm and 1.5 mm, most preferably about 0.5 mm, given a length L of the tapered body of about 1.0 to 2.0 cm.

The exterior of tapered body 11 is threaded with threads 17, preferably over the entire length of tapered body 11. Alternatively, however, the threads need not extend over the entire length of the tapered body so long as the tapered body is threaded sufficiently so as to draw the taper into widening engagement with the interior of the implant site. Thus, it is sufficient for the tapered body to be threaded over only a portion thereof, although it is usually preferable for the lower portion of the tapered body to be threaded so as to assist in the initial stages of drawing the osteotome into the implantation site.

Threads 17 are feeding threads constructed to feed the osteotome into the implantation site. Preferably, the threads are arranged at a pitch of about 10 to 50 threads per cm, most preferably about 20 threads per cm, so that the osteotome is drawn to a (typically) 1.0 cm implantation depth after approximately 10 to 50 rotations. When coupled to a surgical drill that rotates the osteotome at about 200 rpm, which is variable as described below, the osteotome will require about 10 to 15 seconds of rotation to reach the desired depth. Likewise, about 10 to 15 seconds of reverse rotation are required to retract the osteotome from the implantation site. A hand ratchet-type wrench is an alternative method of rotation.

Threads 17 are feeding threads and are not cutting threads intended to cut significantly into the interior of the implantation site. As a consequence, sharpness of threads 17 is not critical and the osteotome can be reused many times without affecting quality or usability.

To assist the surgeon in gauging the depth to which the osteotome has been inserted, depth markings are arranged at pre-designated depths along the length of osteotome 10. As seen in FIG. 1, markings in the form of depth etchings 19 are arranged at positions corresponding to depths of 0.8 cm, 1.0 cm, 1.3 cm and 1.5 cm which in turn corresponds to standard implant lengths. The termination of tapered body 11 corresponds to a depth of 1.0 cm, and together with depth etchings 19 provide the surgeon with graduated depth markings.

As shown in FIG. 1, tip 15 is blunted since such a shape is believed to be most suitable for the base of the implantation site. In addition, the blunt tip assists in initial insertion of the osteotome into the implantation site so as to facilitate proper alignment of the osteotome with the access hole of the implantation site. Other shapes may also be utilized, however, such as a flat shape, a convex shape, or a sharpened shape.

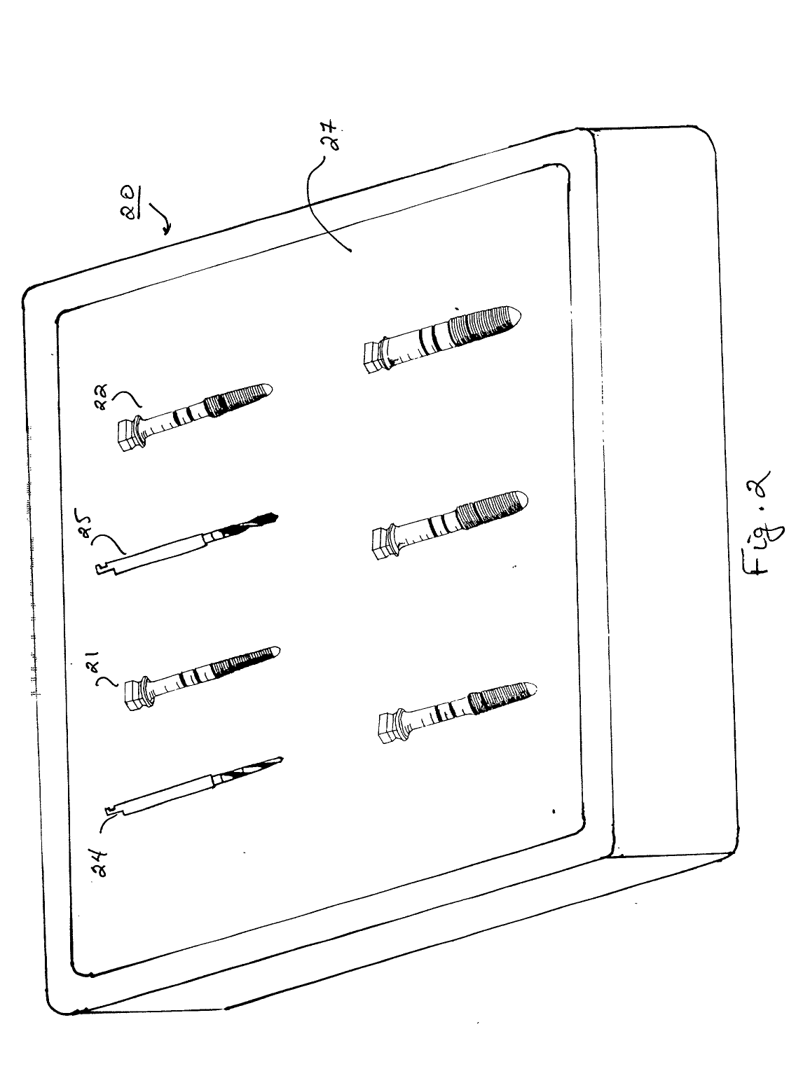

FIG. 2 is a perspective view of a kit of plural osteotomes, each with increasingly larger diameter, which together allow a surgeon to widen the implantation site in graduated steps from the diameter of an initial pilot hole to the desired diameter of the implant cylinder. As seen in FIG. 2, an osteotome kit 20 is provided with plural osteotomes such as osteotomes 21 and 22, with each osteotome having a diameter successively larger than a previous osteotome, but with diameters of successively-sized osteotomes overlapping diameters at opposite ends of the tapers. In particular, and focusing on the diameters of successively-sized osteotomes 21 and 22, the diameters of tip and intermediate regions of the tapered body for osteotome 21 are smaller than corresponding diameters of osteotome 22. At the same time, the diameter of the tip for osteotome 22 is approximately equal to or slightly smaller than the diameter at the intermediate region of the tapered body for osteotome 21. Because the diameters overlap, insertion of the tip of a successively-larger osteotome is facilitated since the previous osteotome has widened the diameter of the implantation site to an amount approximately equal to or slightly larger than the tip diameter of the successive osteotome.

As shown in FIG. 2, each of the osteotomes includes generally identical couplings and depth etchings at generally identical intervals. This arrangement facilitates quick use and exchange of successive osteotomes during preparation of the implantation site, and provides consistent feedback to the surgeon as to the depth to which the implantation site is prepared.

Osteotome kit 20 is preferably provided with pilot drills 24 and 25 whose diameters are slightly larger than the tip diameters in one or two of the osteotomes in the kit. In the embodiment of FIG. 2, the diameter of pilot drill 24 is slightly larger than the tip diameter of osteotome 21, and the diameter of pilot drill 25 is slightly larger than the tip diameter of osteotome 22.

Osteotome kit 20 preferably also includes a molded tray 27 with molded-in receiving portions each sized to receive a corresponding one of the osteotomes or the pilot drills. Preferably, the molded tray is temperature resistant and possibly removable so as to facilitate sterilization of the osteotomes and the drills in the kit, and also to facilitate a quick visual check as to completeness of the kit.

FIG. 3 is a perspective view showing use of the osteotome in widening of an implantation site 31, here in lower jaw 32. As shown in FIG. 3, drill mount 34 of dental drill 35 is engaged to an unshown coupling on osteotome 36. The tip end of osteotome 36 is positioned adjacent the open upper end of implantation site 31, and rotation of the osteotome is commenced. As the osteotome is rotated, its threads engage the interior bony surface of the implantation site, and through continued rotation the threads draw the osteotome into the implantation site, all without any significant cutting or removal of bone tissue. As the osteotome is drawn into the implantation site, the taper of its tapered body causes widening of the implantation site. After the osteotome has been drawn into the implantation site to a desired depth, as indicated from the depth etchings, rotation is reversed, causing the threads on the osteotome to back the osteotome out of the implantation site. At a typical rotation speed of approximately 200 rpm, and the aforementioned thread pitch of about 10 to 50 threads per cm, rotation into the implantation site would take about 10 to 15 seconds, with a like period needed for reverse rotation to back the osteotome out. However, the surgeon can adjust the rotational speed and possibly torque, and preferably will adjust the speed and torque in correspondence to the perceived density of the bone. For example, to reduce trauma even further, and further to minimize bone damage and the possibility of a bone fracture, the surgeon would ordinarily select a slower rotational speed for dense bone (that is, slower than 200 rpm). At this slower rotational speed with possibly higher torque) there is a corresponding decrease in the speed at which the osteotome is drawn into the implantation site and in the speed at which the implantation site is widened. Likewise, for less dense bone, particularly for that of the upper jaw, it is possible to employ a higher rotational speed with a correspondingly higher speed at which the osteotome is drawn into the implantation site and with which the implantation site is widened. A hand wrench can also be used, which in certain circumstances will provide the surgeon with extremely accurate control over the speed and torque with which the osteotome is inserted.

After osteotome 36 is withdrawn from the implantation site, a next successively sized osteotome is employed to widen the site further, until the desired diameter (that is, a diameter corresponding to that of the implant cylinder) is obtained. Thereafter, the implantation site is further prepared as desired, such as by cutting threads in the interior surface of the implantation site, and the implant cylinder is inserted or threaded into the prepared implantation site.

The invention has been described above with reference to a preferred embodiment, but the embodiment is representative only and details thereof are not to be construed as limiting the scope of the invention. In particular, modifications to the preferred embodiment will be apparent to those of ordinary skill in the art, and all such modifications are considered to come within the scope of the invention. Accordingly, the invention is to be measured by reference to the appended claims, as follows.

What is claimed is:

1. A rotary osteotome for widening of a dental implant site comprising:
a tapered body tapered from a tip thereof to a widened intermediate region, at least a part of the tapered body being threaded with feeding threads constructed to draw the tapered body into the implant site responsive to rotation of the body; and
a coupling constructed for detachable engagement with rotation means for forward and reverse rotation of the tapered body.

2. A rotary osteotome according to claim 1, further comprising a shaft connecting the tapered body to the coupling.

3. A rotary osteotome according to claim 2, wherein depth markings are formed on said shaft.

4. A rotary osteotome according to claim 1, further comprising depth markings formed on the tapered body.

5. A rotary osteotome according to claim 1, wherein said tip of the tapered body is blunted.

6. A rotary osteotome according to claim 1, wherein the tapered body tapers between about 0.25 and 1.5 mm from the tip to the widened intermediate region.

7. A rotary osteotome according to claim 6, wherein the tapered body tapers about 0.5 mm from the tip to the widened intermediate region.

8. A rotary osteotome according to claim 1, wherein the feeding threads are spaced at a pitch between about 10 and 50 threads per cm.

9. A rotary osteotome according to claim 8, wherein the feeding threads are spaced at a pitch about 20 threads per cm.

10. A rotary osteotome according to claim 1, wherein an entirety of the tapered body is threaded.

11. A rotary osteotome according to claim 10, further comprising an unthreaded shaft connecting th e coupling and the tapered body.

12. An osteotome kit comprising:
plural osteotomes including at least first and second osteotomes, each osteotome having a tapered body tapered from a tip thereof to a widened intermediate region, at least a part of the tapered body being threaded with feeding threads constructed to draw the tapered body into an implant site responsive to rotation of the body;
wherein diameters of the tip and intermediate regions of the first osteotome are smaller than those of the second osteotome; and
wherein the tip diameter of the second osteotome is approximately equal to or slightly smaller than the diameter of the intermediate region of the first osteotome.

13. An osteotome kit according to claim 12, further comprising a pilot drill whose diameter is approximately equal to or slightly larger than the tip diameter of the first osteotome.

14. An osteotome kit according to claim 12, further comprising a mounting tray with molded receiving portions each sized to respective ones of said plural osteotomes.

15. An osteotome kit according to claim 12, wherein said at least first and second osteotomes each include a shaft connecting the tapered body to a coupling.

16. An osteotome kit according to claim 15, wherein depth markings are formed on said shaft of each of said at least first and second osteotomes.

17. An osteotome kit according to claim 12, wherein depth markings are formed on the tapered body of each of said at least first and second osteotomes.

18. An osteotome kit according to claim 12, wherein said tip of the tapered body of each of said at least first and second osteotomes is blunted.

19. An osteotome kit according to claim 12, wherein the tapered body of each of said at least first and second osteotomes tapers between about 0.25 and 1.5 mm from the tip to the widened intermediate region.

20. An osteotome kit according to claim 19, wherein the tapered body tapers about 0.5 mm from the tip to the widened intermediate region.

21. An osteotome kit according to claim 12, wherein the feeding threads of each of said at least first and second osteotomes are spaced at a pitch between about 10 and 50 threads per cm.

22. An osteotome kit according to claim 21, wherein the feeding threads are spaced at a pitch about 20 threads per cm.

23. An osteotome kit according to claim 12, wherein an entirety of the tapered body of each of said at least first and second osteotomes is threaded.

24. An osteotome kit according to claim 23, wherein each of said at least first and second osteotomes further includes an unthreaded shaft connecting the coupling and the tapered body.

25. A method for widening a dental implant site, comprising:
inserting a tip end of a rotary osteotome into the implant site, the rotary osteotome having a tapered body tapered from the tip thereof to a widened intermediate portion, at least a part of the tapered body being threaded with feeding threads constructed to draw the tapered body into the implant site responsive to rotation of the tapered body;
rotating the osteotome in a forward direction of the threads, thereby to draw the osteotome into the implant site and to widen the implant site from expansion by the intermediate region.

26. A method according to claim 25, further comprising the step of reversing rotation of the rotary osteotome thereby to withdraw the rotary osteotome from the implant site.

27. A method according to claim 26, further comprising the step of shaping the implant site to receive a dental implant.

28. A method according to claim 27, further comprising the step of cutting threads in the implant site to receive a threaded dental implant.

29. A method according to claim 26, further comprising the step of selecting a second rotary osteotome whose diameters at the tip and the intermediate region are larger than those of the rotary osteotome inserted in said inserting step, and repeating said inserting and said rotating steps using said second rotary osteotome.

30. A method according to claim 25, further comprising the step of monitoring depth of the rotary osteotome into the implant site by reference to depth markings on the rotary osteotome, and stopping rotation of the rotary osteotome when a pre-designated depth has been reached.

31. A method according to claim 30, further comprising the step of reverse rotation of the rotary osteotome to withdraw the rotary osteotome from the implant site after the pre-designated depth has been reached.

32. A method according to claim 25, further comprising the step of adjusting speed of rotation in said rotating step, adjustment of speed being made relative to bone density.

33. A method according to claim 32, wherein torque is also adjusted.

34. A method according to claim 25, wherein said rotating step rotates the rotary osteotome for about 10 to 50 rotations.

35. A method according to claim 34, wherein said rotating step rotates the osteotome for about 20 rotations.

36. A method according to claim 25, further comprising the step of coupling the rotary osteotome to a surgical drill, wherein in said rotating step the rotary osteotome is rotated by the surgical drill at about 200 rpm.

37. A method according to claim 25, is wherein said rotating step is performed with a surgical drill.

38. A method according to claim 25, wherein said rotating step is performed with a surgical hand wrench.
